(19) United States
(12) Patent Application Publication
(10) Pub. No.: US 2018/0094805 A1
(43) Pub. Date: Apr. 5, 2018

(54) Hanger with Decorative Lighting, and Method of Use

(71) Applicant: Jie Feng, Niskayuna, NY (US)

(72) Inventor: Jie Feng, Niskayuna, NY (US)

(21) Appl. No.: 15/830,562

(22) Filed: Dec. 4, 2017

Related U.S. Application Data
(60) Provisional application No. 62/577,461, filed on Oct. 26, 2017.

(51) Int. Cl. F21V 33/00; A47G 7/04; A01G 9/02

(52) U.S. Cl. CPC F21V 33/0028; A01G 9/024; A47G 7/045

(57) ABSTRACT

A support line for hanging a basket, comprising: the support line; a line of a plurality of decorative lights disposed along the support line; a basket mating interface proximate its bottom extremity; and an electrical conductor providing electrical power to the decorative lights.

### CROSS-REFERENCE TO RELATED APPLICATIONS

This application claims priority benefit of U.S. provisional application 62/577,461 filed Oct. 26, 2017, which is hereby incorporated by reference in its entirety.

### BACKGROUND OF THE INVENTION

Hanging holiday lights is difficult and time consuming. Hanging plant and similar baskets is simple, and often consumers have plants which are already hanging. By providing decorative, festive lights integrated with a hanger for a basket containing plants or other items, decorating for the holidays or for parties and other events is greatly simplified.

The prior art does reveal a few plant hangers which contain lights. For example, U.S. Pat. No. 5,860,248; U.S. Pat. No. 8,454,209; U.S. Pat. No. 9,572,304 and U.S. D667,579 are configured to illuminate plants inside the basket, not provide decorative lighting per se, and are not light strings. U.S. Pat. No. 9743790, in turn, merely provides a structure to hang separate light strings.

It is desirable to provide a means to hanging decorative lighting strings quickly and efficiently, whereby light decorating tasks that ordinarily take the better part of an hour or more, can be completed in a matter of second or minutes.

### SUMMARY OF THE INVENTION

A plant or other basket hanging support line integrated with a line of decorative lights and related method of use. This is part of a hanger for plant or other basket types, in combination with festive lighting to simplify deploying holiday and other decorative lighting.

Specifically, disclosed is a support line in various configurations for hanging a basket, and associated method, comprising: the support line; a line of a plurality of decorative lights disposed along the support line; a basket mating interface proximate its bottom extremity; and an electrical conductor providing electrical power to the decorative lights.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 illustrates a plant hanger with three (3) plant hanging support lines, each integrated with a line of decorative lights. Three lines is common for a plant hanger, but three lines shown here rather than some other number is for example, not limitation.

FIG. 2 illustrates the plant hanger of FIG. 1, attached to a plant basket and hanging the plant basket.

FIG. 3 is a photograph illustrating an early-stage prototype of the hanger of FIG. 1.

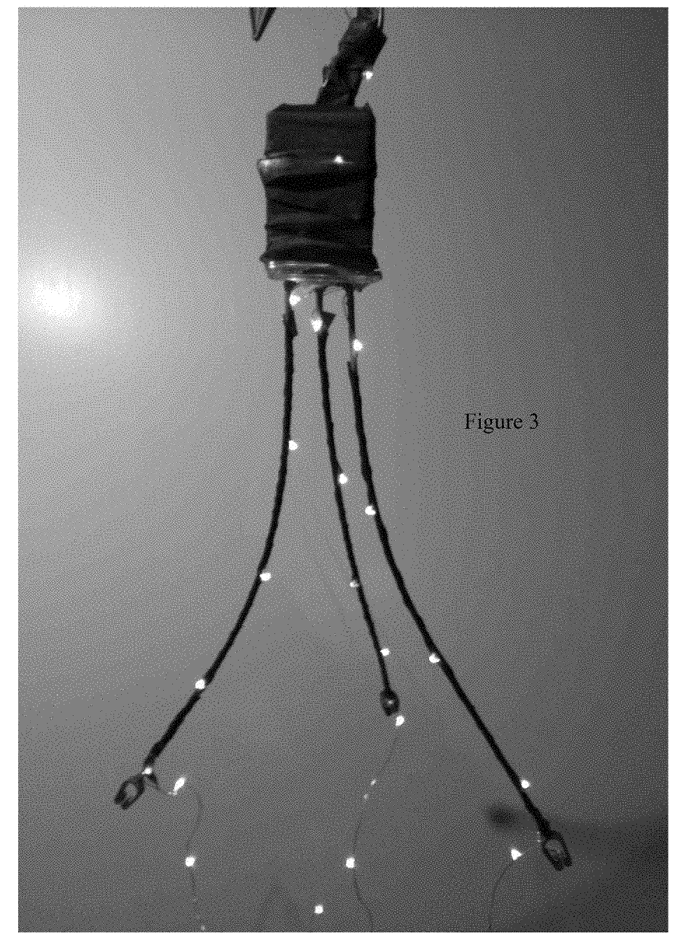

FIG. 4 is a photograph illustrating the prototype of FIG. 3 hanging a basket in the manner of FIG. 2.

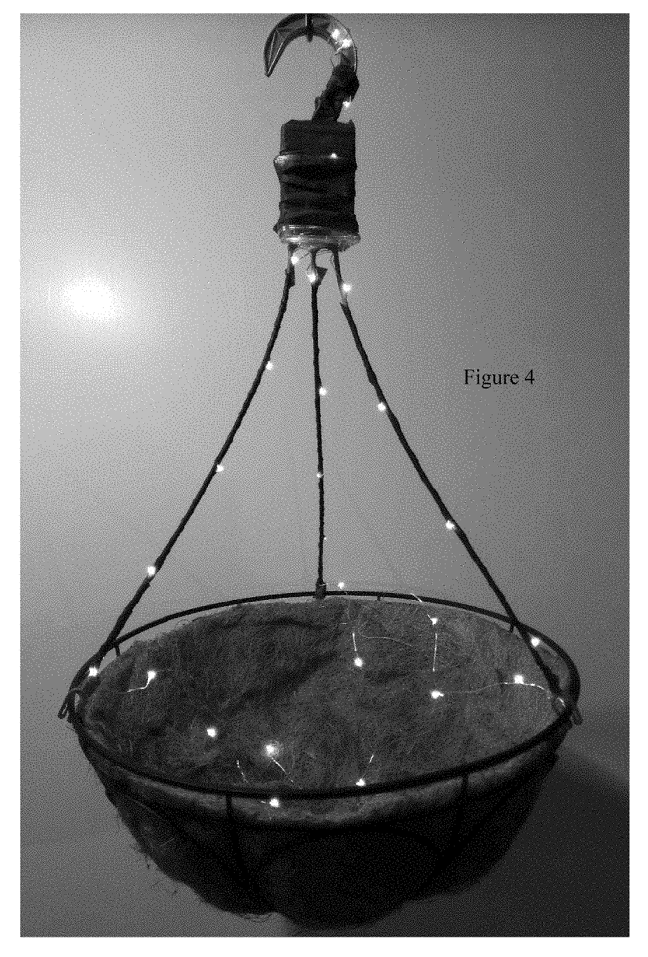

FIG. 5 is a photograph illustrating the prototype configuration of FIG. 4 in low-light conditions, with the basket carrying several decorative items, all highlighting how the decorative lights of the invention will appear at night.

### DETAILED DESCRIPTION

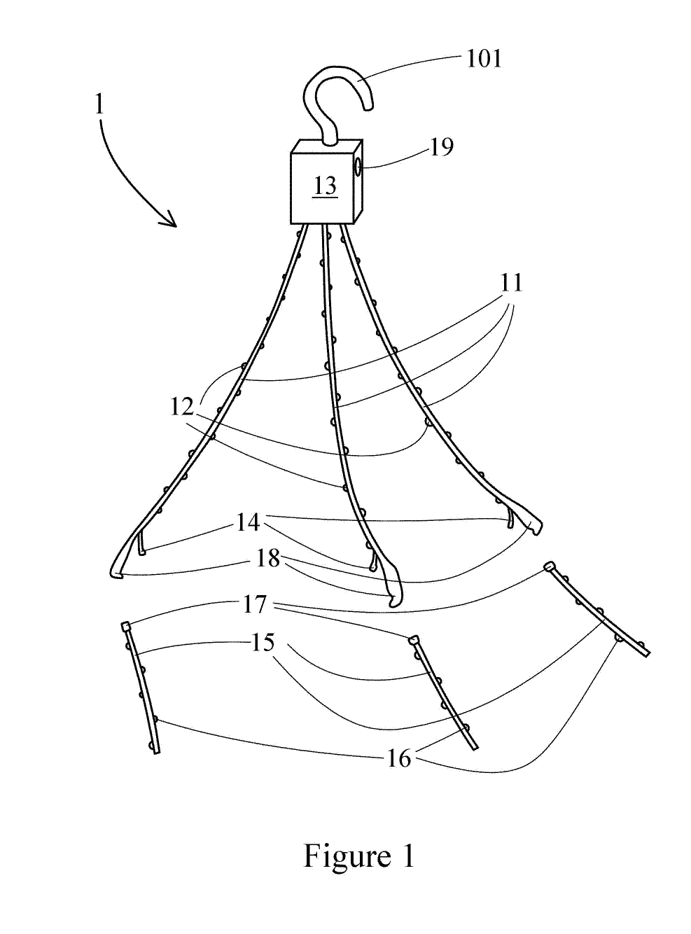

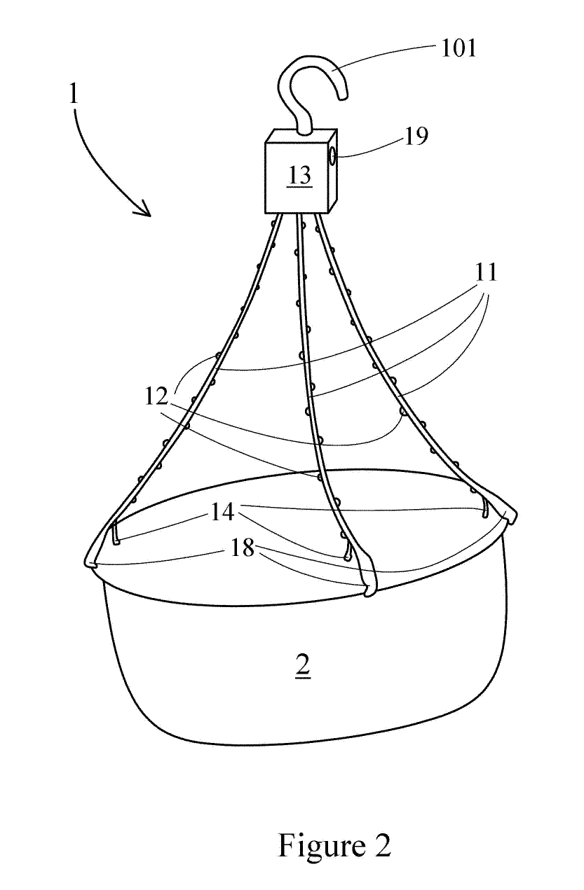

Referring to FIGS. 1 and 2, the baskets 2 which may be hung with the present invention are supported by at least three hanger support lines 11. These hanger support lines 11 comprise a plurality of tiny decorative lights 12 on their surfaces. These support lines 11 themselves are elongated as illustrated, and may be fabricated from, for example not limitation, plastic, metal, chains, polycord, and fabric constructs such as cotton, hemp, and macrame, and/or equivalents to all of the foregoing. The hanger support lines 11 also comprise a basket mating interface 18 at their bottom extremities, which may include basket hooks or latches which are illustrated. Or, for example not limitation, if the support lines 11 comprise a soft, flexible fabric such as but not limited to macrame, then these support lines 11 and the basket mating interface 18 may simply comprise a cradle or other support configuration for the basket 2 which does not contain hooks or latches, in manners such as are exemplified by the photograph at http://cdn.designrulz.com/wp-content/uploads/2015/07/2-Macrame-Eye-Candy-designrulz-2.jpg which is also included in an information disclosure being filed with this application.

These lights 12 are not grow lights such as one normally expects to see used in connection with plants. Rather, they are decorative, festive lights. The invention is useful especially during Thanksgiving and Christmas times, but also for parties and similar events. These lights connect with a waterproof power center 13 under hanging mechanism 101 such as a hook or equivalent. The power center 13 has an electronic controller with suitable computer chips and the like to offer one or more of several functions:
1) Automatic Timer (for example, not limitation, 5 hours on 19 hours off).
2) Different modes of lights, e.g., chasing effect so they are shining one after another to build up an enjoyable atmosphere for holidays. Or color variability among the various lights. This decorative lighting function patentably distinguishes hangers which only provide plant grow lights, in which the lighting is for plant growth only, not for decoration in accordance with the present invention.
3) Central serial power supply function. At the end of three (or more) hanger support lines 11, there is a schematically-illustrated male or female connection plug 14. These plugs 14 can independently connect with three additional strings 15 of lights 16 as long as they have opposite-gendered schematically-illustrated connection plugs 17. These additional strings 15 of lights 16 can hang under the roof or on the surface of plants, etc. Therefore, a customer can decorate a porch or other space with minimal work in minimal time.
4) The power center 13 atop the hanger and decorative light apparatus 1 at the hanger's upper terminus may also have a connection that allows planters to be daisy-chained together. So for a hanger and decorative light apparatus 1 with three support lines, a first hanger 1 can power three additional hangers 1, each of which can power three more, etc., for a multiplier effect.
5) In relation to this daisy-chain configuration, the power center 13 may also have a power receptacle 19 to receive power from an external source, which may be another hanger 1, or may be any other type of external power source.

This invention is novel because there does not appear to be a similar existing product in the prior art.

This invention is non-obvious because there is no teaching or motivation to modify existing plastic hangers to incorporate the invention, nor would the function of growing and hanging plants in any way suggest using the hanging supports for decorative lighting so as to reduce the time required to deploy decorative light strings. It has a power center 13 under the hanging mechanism 101 and above the hanger support lines 11 which may be nicely designed to add to the festive characteristics of the invention. Inside the power center 13 may be batteries and programmable controller chip, or any other electrical configuration suitable to operate the invention. Power may also be from an outlet or any other power source. And again, the power center 13 may be able to receive power from other planters 1 in a daisy chain configuration. Finally, it is not obvious to use plant hangers to provide decorative lighting integrated therein. Lighting for plants is generally expected to serve the function of growing the plant, not providing collateral decoration.

The power center 13 is safe and waterproof so that water won't erode the batteries. The tiny lights 12, 16 are nicely arranged on the surface of hanger support lines 11. In production models the electrical wire should be preferably hidden from view. Nevertheless, despite this preference, a hanger 1 with the wire partly or wholly visible is still regarded to be within the scope of this disclosure and its associated claims. A customer or a plant hanger maker cannot easily replicate this product without making wholesale configuration changes which are not taught or motivated or suggested by the prior art.

This product especially provides convenience to seniors and other consumers. Decoration of their porch or other display space ordinarily requires a lot of work and time. These users need to sort out a long, often-tangled string of lights and hang this under a roof or over some plants. They need to usually deal with multiple lines. Multiple lines can be easily mixed and messed up together. Collecting them back requires even more work. This is a headache for many, even young consumers. Now consumers just need to connect these decorative hangers to plant baskets and hang these under the roof or other overhead attachment point, flick the switch, and enjoy the lighting. It takes 30 seconds or less of time, and the lighting display is done.

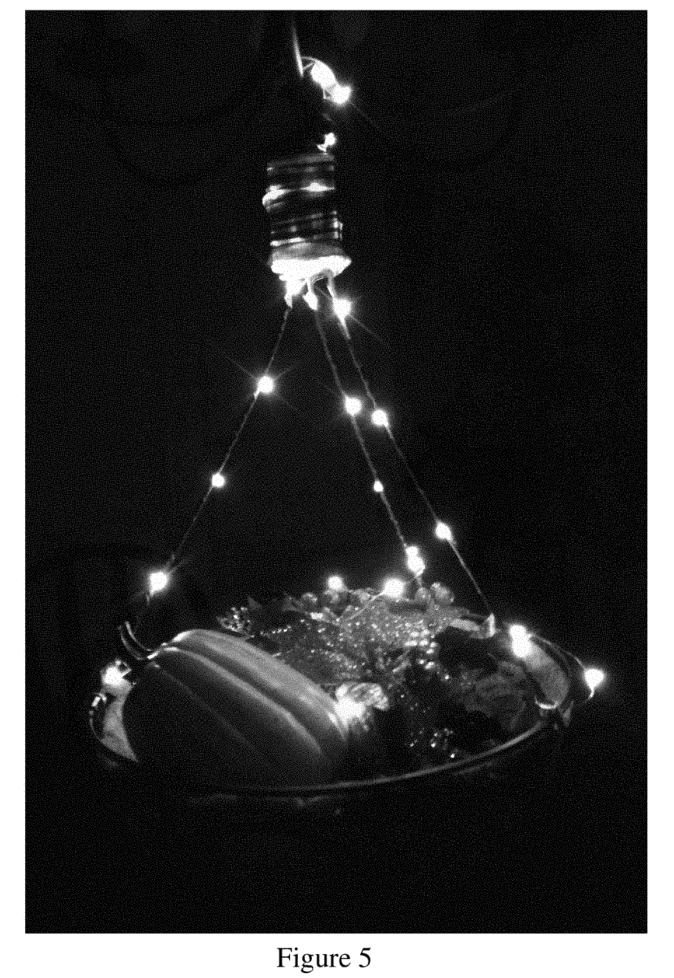

Although the preferred embodiment of the invention uses these hanger supports to hang a basket containing plants, it is envisioned that baskets of any other ornamental or decorative items, party favors, etc. might also be hung and decoratively lit in accordance with the invention. FIG. 5 is an illustration of this.

It bears reemphasis that the method by which this invention is used saves a great deal of time when assembling a decorative lighting display. The user simply hangs the basket 2 from the hanger 1, hangs the entire assembly via hanging mechanism 101 from an overhead mounting location, provides power via the power center 13, and turns on the power. Multiple hangers 1 may then be daisy-chained together as discussed. A task of stringing lines of decorative lights that often takes close to an hour or more of work, may be completed in a matter of seconds or a few minutes.

The knowledge possessed by someone of ordinary skill in the art at the time of this disclosure, including but not limited to the prior art disclosed with this application, is understood to be part and parcel of this disclosure and is implicitly incorporated by reference herein, even if in the interest of economy express statements about the specific knowledge understood to be possessed by someone of ordinary skill are omitted from this disclosure. While reference may be made in this disclosure to the invention comprising a combination of a plurality of elements, it is also understood that this invention is regarded to comprise combinations which omit or exclude one or more of such elements, even if this omission or exclusion of an element or elements is not expressly stated herein, unless it is expressly stated herein that an element is essential to applicant's combination and cannot be omitted. It is further understood that the related prior art may include elements from which this invention may be distinguished by negative claim limitations, even without any express statement of such negative limitations herein. It is to be understood, between the positive statements of applicant's invention expressly stated herein, and the prior art and knowledge of the prior art by those of ordinary skill which is incorporated herein even if not expressly reproduced here for reasons of economy, that any and all such negative claim limitations supported by the prior art are also considered to be within the scope of this disclosure and its associated claims, even absent any express statement herein about any particular negative claim limitations.

Finally, while only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. A support line for hanging a basket, comprising:
said support line;
a line of a plurality of decorative lights disposed along said support line;
a basket mating interface proximate its bottom extremity; and
an electrical conductor for providing electrical power to said decorative lights.

2. The support line of claim 1, further comprising a basket hanging from a lower end of said support line.

3. The support line of claim 1, further comprising at least two additional said support lines, all merged at an upper terminus thereof to form a hanger and decorative light apparatus; and
said upper terminus comprising a hook or equivalent means for hanging from an overhead mounting location.

4. The hanger and decorative light apparatus of claim 3, further comprising a basket hanging from a lower end of said at least three support lines.

5. The hanger and decorative light apparatus of claim 4, said basket comprising a plant hanging basket.

6. The support line of claim 1, further comprising an electrical connector at a bottom end thereof configured to electrically mate with an electrical connector of another said support line.

7. The hanger and decorative light apparatus of claim 3, each of said at least three support lines further comprising an electrical connector at bottom ends thereof configured to electrically mate with an electrical connector of a separate said hanger and decorative light apparatus, for configuring an electrically serial daisy-chained system of said hanger and decorative light apparatuses.

8. The hanger and decorative light apparatus of claim 3, further comprising an electrical connector for receiving power from a separate said hanger and decorative light apparatus, for configuring an electrically serial daisy-chained system of said hanger and decorative light apparatuses.

9. A method of deploying decorative lights, comprising:
providing at least three support lines for hanging a basket, each said support line comprising said support line, a line of a plurality of decorative lights disposed along said support line, a basket mating interface proximate its bottom extremity, and an electrical conductor providing electrical power to said decorative lights, all merged at an upper terminus thereof to form a first hanger and decorative light apparatus;
hanging said decorative light apparatus from an overhead mounting location; and
providing electrical power to and thereby actuating said decorative lights via said electrical conductors.

10. The method of claim 9, further comprising:
providing at least one additional said hanger and decorative light apparatus in addition to the first said hanger and decorative light apparatus;
serially electrically connecting said at least one additional said hanger and decorative light apparatus to an electrical connector at a bottom end of at least one of said support lines of said first hanger and decorative light apparatus; and
electrically powering said first hanger and decorative light apparatus, and thereby actuating the decorative lights of said serial connection of said hanger and decorative light apparatuses in a daisy-chained configuration.

11. The method of claim 10, further comprising said at least one additional said hanger and decorative light apparatus receiving power from said first hanger and decorative light apparatus.

12. The method of claim 9, further comprising hanging a basket from a lower end of said support lines.
